(19) United States
(12) Patent Application Publication
(10) Pub. No.: US 2020/0332570 A1
(43) Pub. Date: Oct. 22, 2020

(54) CLOSURE LATCH ASSEMBLY WITH POWER ACTUATOR HAVING MOTOR RESET MECHANISM

(71) Applicant: Magna Closures, Inc., Newmarket (CA)

(72) Inventor: Kris TOMASZEWSKI, Newmarket (CA)

(21) Appl. No.: 16/847,762

(22) Filed: Apr. 14, 2020

Related U.S. Application Data
(60) Provisional application No. 62/834,579, filed on Apr. 16, 2019.

(51) Int. Cl. E05B 81/16; E05B 81/06; E05B 81/20; E05B 79/20; E05B 81/34

(52) U.S. Cl. CPC E05B 81/16; E05B 81/06; E05B 81/34; E05B 79/20; E05B 81/20

(57) ABSTRACT

The present disclosure relates to a closure latch assembly for a vehicle door, and more particularly to a closure latch assembly for a vehicle door equipped with a non-powered reset feature. A power actuator actuates an actuatable mechanism in a power-on state, and a reset mechanism to reset the actuatable mechanism when the power actuator is in a power-off state. The reset mechanism is directly coupled to a motor shaft of an electric motor associated with the power actuator. The reset mechanism includes a pulley biased to a rest position by a spring, and a drive cable wrapped around the pulley and the motor shaft. Actuation of the motor winds the cable around the motor shaft and rotates the pulley against its bias. In the power-off state, the pulley rotates back to the rest position and unwinds the cable from the motor shaft, rotating the shaft and resetting the motor.

### CROSS-REFERENCE TO RELATED APPLICATIONS

This application claims benefit of the benefit of previously filed U.S. Provisional Application No. 62/824,579 which was filed Apr. 16, 2019, which is incorporated herein by reference in its entirety.

### FIELD OF THE INVENTION

The present disclosure is generally related to closure latch assemblies of the type installed in closure panels used in motor vehicle closure systems. More particularly, the present disclosure is directed to a closure latch assembly having a power-operated actuator operable in a powered state to shift an actuatable mechanism from a non-actuated state into an actuated state, and an actuator reset mechanism operable for subsequently shifting the actuatable mechanism back into its non-actuated state in response to the actuator operating in a non-powered state.

### BACKGROUND OF THE INVENTION

This section provides background information related to closure latches and is not necessarily prior art to the closure latch of the present disclosure.

In view of consumer demand for motor vehicles equipped with advanced comfort and convenience features, many modern vehicles are now provided with a passive keyless entry system to permit locking, unlocking and release of closure panels (i.e. passenger doors, tailgates, liftgates, decklids, etc.) without the use of a traditional key-type entry system. Some of the most popular features now available in association with closure systems include power locking/unlocking, power release and power cinching. These “powered” features are provided by a closure latch assembly mounted to the closure panel and equipped with a latch mechanism, a power-operated latch release mechanism and/or a power-operated latch cinch mechanism. Typically, the latch mechanism includes a ratchet and pawl arrangement configured to latch the closure panel in a closed position by virtue of the ratchet being held in a striker capture position to releasably engage and retain a striker that is mounted to a structural portion of the vehicle. The ratchet is held in its striker capture position by the pawl mechanically engaging the ratchet in a ratchet holding position. In many closure latch assemblies, the latch mechanism is configured such that the pawl is operable in its ratchet holding position to mechanically engage and retain the ratchet in at least two distinct striker capture positions, namely a secondary (i.e. “soft close”) striker capture position and a primary (i.e. “hard close”) striker capture position.

In closure latch assemblies providing a power release feature, a power release actuator is selectively actuated to cause the latch release mechanism to move the pawl from its ratchet holding position into a ratchet releasing position, whereby a ratchet biasing arrangement is permitted to forcibly pivot the ratchet from its striker capture position(s) into a striker release position for releasing the striker and allowing movement of the closure panel from its closed position to an open position. In closure latch assemblies providing a power cinching feature, a power cinch actuator is selectively actuated to cause the latch cinch mechanism to pivot the ratchet from its secondary striker capture position into its primary striker capture position, while the pawl is maintained in its ratchet holding position, thereby cinching the closure panel from a partially-closed position into a fully-closed position. A common electrically powered actuator, or separate electrically-powered actuators, can be associated with the power release and power cinching features. However, the power release feature is typically independent from the power cinching feature.

In many closure latch assemblies providing the power release feature, the latch release mechanism is normally maintained in a non-actuated state and is only shifted into an actuated state when sensors indicate a door release operation has been requested and authenticated by the passive keyless entry system (i.e. via actuation of a key fob or a handle-mounted switch). Actuation of the power release actuator is required for shifting the latch release mechanism from its non-actuated state into its actuated state. Following completion of the power release operation, when the sensors indicate that the ratchet is located in its striker release position, the latch release mechanism must be “reset”, that is returned to its non-actuated state, to permit subsequent latching of the latch mechanism upon movement of the closure panel toward its closed position(s).

In closure latch assemblies providing the power cinching feature, the latch cinch mechanism is normally maintained in a non-actuated state and is only shifted into an actuated state when sensors indicate that the ratchet is located in its secondary striker capture position. Actuation of the power cinch actuator is required for shifting the latch cinch mechanism from its non-actuated state into its actuated state. Following completion of the power cinching operation, when the sensors indicate that the ratchet is located in its primary striker capture position, the latch cinch mechanism must be “reset”, that is returned to its non-actuated state, to permit subsequent uninhibited movement of the ratchet to its striker release position via actuation of the latch release mechanism.

In many closure latch assemblies providing the power release feature and/or the power cinching feature, the power-operated actuator includes a reverse-drivable electric motor and a gear reduction unit configured to be driven in a first direction to actuate the latch release mechanism and/or the latch cinch mechanism and in a second direction to reset the corresponding mechanisms. In power release configurations, the power release actuator requires an electric motor sized to provide an actuation or “latch opening” force capable of overcoming the frictional forces between the ratchet and pawl, typically due to the seal forces exerted between the striker and the ratchet, for moving the pawl to its ratchet releasing position. In power cinching configurations, the power cinch actuator requires an electric motor sized to provide an actuation or “latch cinching” force capable of pivoting the ratchet from its secondary striker capture position into its primary striker capture position in opposition to the biasing exerted on the ratchet by the ratchet biasing arrangement. In both power configurations, the force requirements associated with the electric motors to reset (i.e., the “reset force”) the latch release mechanism and/or the latch cinch mechanism is significantly less than the actuation force.

As noted, the electric motor is driven in the first or “actuation” direction to actuate an actuatable (i.e. latch release, latch cinch, etc.) mechanism and is subsequently driven in the second or “reset” direction to reset the actuatable mechanism. However, reversing powered operation of the electric motor to provide such a “power reset” function is known to generate noise and excessive friction which is undesirable. In addition, a loss of power to the closure latch assembly could prevent power resetting of the actuatable mechanism. As such, some closure latch assemblies include a reset spring which functions in cooperation with the gear reduction unit to back drive the electric motor in the second direction for providing a non-powered reset function. However, system efficiency and complexity is compromised since a large reset spring is required to generate the back drive torque. Alternatively, it is known to have the reset spring interact directly with the motor shaft. However, such a “direct” reset spring configuration, without an intermediate gear reduction arrangement, requires high ratios which, in turn, leads to high tension and stresses acting on the reset spring and its mounting components.

In view of the above, a recognized need exists to address current shortcomings associated with power-operated closure latch assemblies and provide solutions that advance the art and still meet all safety and regulatory requirements, such as a motor reset mechanism configured to provide a non-powered reset function.

### SUMMARY

This section provides a general summary of the disclosure and is not intended to be considered as a comprehensive and exhaustive listing of its full scope or all of its aspects, features and objectives.

It is an aspect of the present disclosure to provide a closure latch assembly having a power-operated actuator operable in a powered state to shift an actuatable mechanism from a non-actuated state into an actuated state, and a reset mechanism for subsequently shifting the actuatable mechanism back to its non-actuated state when the power-operated actuator is shifted into a non-powered state so as to provide a non-powered reset function.

It is a related aspect of the present disclosure to configure the power-operated actuator to include an electric motor having a motor shaft, and a gear reduction unit operatively coupling the motor shaft to the actuatable mechanism such that rotation of the motor shaft in a first direction in response to powered operation of the electric motor causes the gear reduction unit to shift the actuatable mechanism from its non-actuated state into its actuated state. The reset mechanism is configured to forcibly rotate the motor shaft in a second direction in response to the electric motor being shifted into its non-powered state so as to cause the gear reduction unit to shift the actuatable mechanism from its actuated state back to its non-actuated state to complete the non-powered reset function.

In a further related aspect, the actuatable mechanism is one of a latch release mechanism and a latch cinch mechanism.

In accordance with these aspects, the reset mechanism includes a coil spring, a drive pulley coupled to the coil assembly, an arbor fixed to the motor shaft and a drive cable connected between the drive pulley and the arbor. Rotation of the motor shaft in the first direction causes the drive cable to wind on the motor shaft and drive the drive pulley in a first direction for loading the coil spring to establish a spring-loaded state for the reset mechanism. Upon the electric motor being powered-off, the spring load in the coil spring is released for mechanically driving the drive pulley in a second direction which, in turn, drives the motor shaft in the second direction to define a spring-released state of the reset mechanism.

In accordance with these and other aspects, the present disclosure is directed to a closure latch assembly for a closure panel of a motor vehicle closure system. The closure latch assembly includes a latch mechanism, and a power actuator having an electric motor with a rotary motor shaft, an actuatable mechanism and a reset mechanism. The latch mechanism is operable in a first state to locate the closure panel in a first position and in a second state to permit movement of the closure panel to a second position. The actuatable mechanism is operable in a non-actuated state to permit the latch mechanism to operate in its first state and in an actuated state to shift the latch mechanism from its first state into its second state. The electric motor is operable in a powered state to drive the motor shaft in an actuation direction for causing the actuatable mechanism to shift from its non-actuated state into its actuated state. The reset mechanism is connected to the motor shaft and is operable in a spring-loaded state when the actuatable mechanism is shifted into its actuated state and is further operable in a spring-released state when the electric motor is operating in a non-powered state. In its spring-released state, the reset mechanism exerts a return torque on the motor shaft which functions to drive the motor shaft in a reset direction which, in turn, causes the actuatable mechanism to shift from its actuated state into its non-actuated state, thereby providing a non-powered reset function.

The closure latch assembly of the present disclosure is configured such that the actuatable mechanism is a latch release mechanism operable in its non-actuated state to maintain the latch mechanism in either of its first (latched) and second (unlatched) state and is operable in its actuated state to shift the latch mechanism from its latched state into its unlatched state. The latch mechanism is operable in its latched state to hold the closure panel in its first (closed) position and is operable in its unlatched state to permit movement of the closure panel to its second (open) position. The shifting of the reset mechanism into its spring-released state results in the return torque being exerted on the motor shaft for rotating the motor shaft in the reset direction so as to drive the latch release mechanism back to its non-actuated state with the power release electric motor in its non-powered state.

The closure latch assembly of the present disclosure is configured such that the actuatable mechanism is a latch cinch mechanism operable in its non-actuated state when the latch mechanism is operating in its first (secondary latched) state for holding the closure panel in its first (partially closed) position. The latch cinch mechanism is operable in its actuated state to shift the latch mechanism from its secondary latched state into its secondary (primary latched) state for moving the closure panel from its partially-closed position to its second (fully-closed) position. The shifting of the reset mechanism into its spring-released state results in the return torque being applied to the motor shaft for rotating the motor shaft in the reset direction so as to drive the latch cinch mechanism back to its non-actuated state with the power cinch electric motor in its non-powered state.

In accordance with these alternative, non-limiting embodiments, the reset mechanism is operably associated with a shaft extension segment of the motor shaft and is configured to provide a reduction ratio without use of a gearset by using a pulley-type arrangement. This arrangement includes an arbor fixed to the shaft extension segment of the motor shaft, a pulley, a drive cable wound on the pulley and having a first end fixed to the arbor and a second end fixed to the pulley, and a reset spring acting on the pulley. The spring is pre-loaded and configured to bias the pulley to rotate in a first direction which, in turn, biases the motor shaft to rotate in its reset direction. Rotation of the motor shaft in the actuation direction in response to powered operation of the electric motor causes the drive cable to wind on the motor shaft extension and drive the pulley in a second direction, thereby loading the reset spring and establishing the spring-loaded state. Upon the electric motor being powered off, the spring load of the reset spring is permitted to drive the pulley in the first direction so as to drive the motor shaft in the reset direction.

It is another aspect of the present disclosure to provide a closure latch assembly for a vehicle having a latch mechanism, a latch release mechanism, and a power release mechanism for controlling powered actuation of the latch release mechanism to provide a power releasing function. The power release mechanism is also configured to provide a non-powered reset function.

In another aspect, a non-powered motor reset mechanism for use in a closure latch assembly for a closure panel of a motor vehicle is provided, the motor reset mechanism comprising: a power actuator including an actuatable mechanism; an electric motor operable in a first rotational direction from a non-actuation position to an actuated position to actuate the actuatable mechanism and operable in a second rotational direction from the actuated position to the non-actuated position to reset the actuatable mechanism; a rotatable pulley unit operatively coupled to the electric motor, wherein the rotatable pulley unit has a rest position and a loaded position, wherein the rotatable pulley has a bias toward the rest position; a drive cable attached to the pulley unit and configured to be wound and unwound from the pulley unit in response to rotation of the pulley unit, wherein the drive cable is further attached to the electric motor; wherein, in response to actuation of the motor, rotation of the motor in the first rotational direction causes rotation of the pulley unit toward the loaded position and unwinds the drive cable from the pulley unit and increases a tension on the drive cable and the bias of the pulley unit; wherein, in response to ceasing actuation of the motor, the bias of the pulley unit causes rotation of the motor in second rotational direction and winds the drive cable on the pulley unit.

In one aspect, the pulley unit includes a spring attached thereto, wherein the spring biases the pulley unit toward the rest position, wherein the spring provides a biasing force when the pulley unit is in the rest position.

In one aspect, the drive cable is coupled to a shaft extension of the motor, wherein rotation of the motor winds the drive cable around the shaft extension and unwinds the drive cable from the pulley unit.

In one aspect, a diameter of the pulley unit is greater than a diameter of the shaft extension, wherein the pulley unit rotates less than the shaft extension to reset the motor.

In one aspect, when the motor is rotated to the actuation position, torque provided on the drive cable by the pulley unit is greater than a torque required to rotate the motor and a gear train driven by the motor under no load condition, wherein ceasing actuation of the motor provides a no load condition, and wherein the torque provided on the drive cable causes the motor to reset under the no load condition.

Further areas of applicability will become apparent from the description provided herein. The description and specific embodiments listed in this summary are for purposes of illustration only and are not intended to limit the scope of the present disclosure.

### BRIEF DESCRIPTION OF THE DRAWINGS

The drawings described herein have been provided to illustrate selected embodiments and specific features thereof and are not intended to limit the scope of the present disclosure. The present disclosure will now be described by way of example only with reference to the attached drawings, in which:

FIG. 1 is an isometric view of a motor vehicle with a passenger door that is equipped with a closure latch assembly embodying the teaching of the present disclosure;

FIG. 2 is an isometric view of a closure latch assembly equipped with a latch mechanism and a power-operated latch release mechanism;

FIG. 3 is an isometric view showing various components of the power-operated latch release mechanism associated with the closure latch assembly shown in FIG. 2;

FIG. 4 is a plan view of the components associated with an alternative configuration of a bidirectional power-operated latch release mechanism associated with the closure latch assembly of the present disclosure;

FIG. 5 is an isometric view of various components associated with the power-operated latch release mechanism shown in FIG. 4;

FIG. 6A illustrates a power release gear associated with the power-operated latch release mechanism shown in FIGS. 4 and 5 located in a neutral/home position, and

FIG. 6B illustrates the power release gear rotated in a first direction from its neutral/home position to a first released position when the closure latch is operating in a normal mode;

FIG. 7A illustrates the power release gear located in its neutral/home position and FIG. 7B illustrates rotation of the power release gear in a second or “emergency” release direction from its neutral/home position to a second released position when the closure latch assembly is operating in an emergency mode;

FIG. 8 illustrates another version of a bidirectional power-operated latch release mechanism with the power release gear shown in its neutral/home position;

FIG. 9 is similar to FIG. 8 except that the power release gear is shown rotated from its neutral/home position to its first released position for providing a spring-loaded resetting function;

FIG. 10 shows the power release gear rotated from its neutral/home position to its second released position;

FIG. 11 illustrates a portion of another closure latch assembly equipped with a motor reset mechanism constructed according to the present disclosure and configured to provide a non-powered reset functionality;

FIGS. 12A and 12B are an isometric and enlarged isometric views respectively of the motor reset mechanism shown in FIG. 11 operating in a spring-released state;

FIGS. 13A and 13B are similar to FIGS. 12A and 12B but now illustrate the motor reset mechanism operating in a spring-loaded state.

FIGS. 14 and 15 are exploded isometric views of the motor reset mechanism of FIG. 11; and

FIG. 16 is an exploded view of a closure latch assembly having the motor reset mechanism of FIG. 11 disposed therein, and further illustrating other components of the closure latch assembly.

### DETAILED DESCRIPTION

Example embodiments of closure latch assemblies for use in motor vehicle door closure systems are provided so that this disclosure will be thorough, and will fully convey the scope to those who are skilled in the art. The present disclosure is specifically directed to implementing a non-powered reset mechanism in the closure latch assembly in association with a power-operated actuatable mechanism. While the actuatable mechanism is disclosed to be a latch release mechanism, the teachings of the present disclosure relating to the non-powered reset mechanism are applicable to use with other power actuators. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

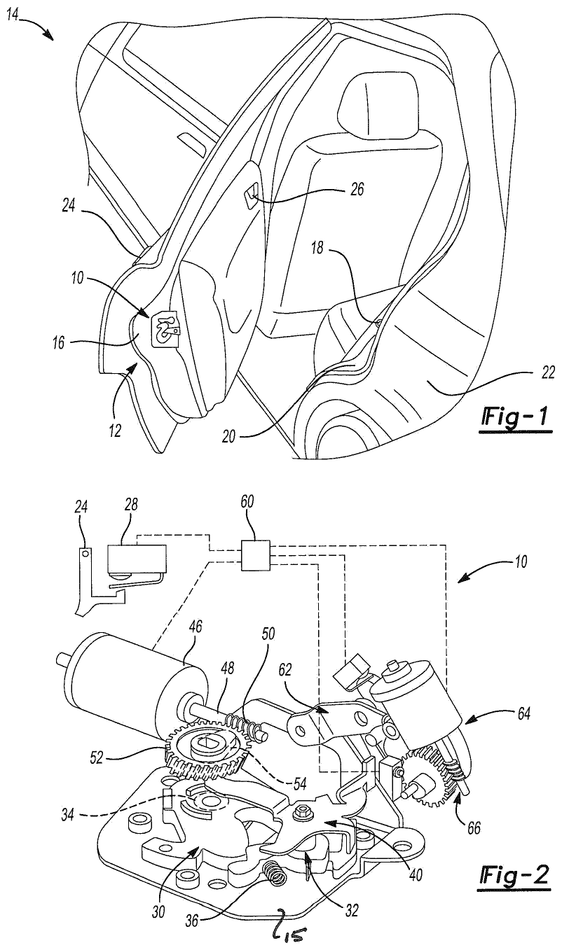

Referring initially to FIG. 1, a closure latch assembly 10 for a passenger door 12 of a motor vehicle 14 is shown positioned along a rear edge portion 16 of door 12 and is configured to releaseably engage a striker 18 secured in a door opening 20 formed in the vehicle's body 22 in response to movement of door 12 from an open position (shown) to a closed position. Door 12 includes an outside door handle 24 and an inside door handle 26, both of which are operatively coupled (i.e. electrically and/or mechanically) to closure latch 10.

Referring now to FIG. 2, a non-limiting embodiment of closure latch assembly 10 is shown to generally include a latch mechanism, a latch release mechanism, a power release actuator, and a power lock actuator. The latch mechanism includes a ratchet 30 and a pawl 32. Ratchet 30 is mounted to a latch plate 15 and moveable between a first or “striker capture” position whereat the ratchet 30 retains striker 18 and a second or “striker release” position whereat ratchet 30 permits release of striker 18. A ratchet biasing member, such as a torsion spring 34, biases ratchet 30 toward its striker release position. Pawl 32 is also mounted to latch housing 15 and is pivotably moveable relative to ratchet 30 between a first or “ratchet holding” position whereat pawl 32 holds ratchet 30 in its striker capture position and a second or “ratchet releasing” position whereat pawl 32 permits ratchet 30 to move to its striker release position. A pawl biasing member, such as a coil spring 36, biases pawl 32 toward its ratchet holding position. With pawl 32 located in its ratchet holding position for mechanically holding ratchet 30 in its striker capture position, the latch mechanism is considered to be operating in a latched state. In contrast the latch mechanism is considered to be operating in an unlatched state when pawl 32 is located in its ratchet releasing position and ratchet 30 is located in its striker release position.

The latch release mechanism includes, among other things, a pawl release lever 40 operatively connected to pawl 32 and which is movable between a first or “pawl release” position whereat pawl release lever 40 causes pawl 32 to move from its ratchet holding position to its ratchet releasing position and a second or “home” position whereat pawl release lever 40 permits pawl 32 to be maintained in its ratchet holding position. A pawl release lever biasing member, such as a suitable pawl release lever spring 42, is provided to bias pawl release lever 40 to its home position. Pawl release lever 40 may be moved from its home position to its pawl release position by several components such as, for example, inside and/or outside handle-actuated release mechanisms in addition to the power release actuator. With pawl release lever 40 located in its home position, the latch release mechanism is defined to be operating in a non-actuated state. In contrast, the latch release mechanism is defined to be operating in an actuated state when pawl release lever 40 is located in its pawl release position.

The power release actuator includes, among other things, a power release electric motor 46 having a rotatable motor shaft 48, a power release worm gear 50 secured for rotation with motor shaft 48, a power release gear 52, and a power release cam 54. Power release cam 54 is connected for common rotation with power release gear 52 and is rotatable between a first or “pawl release” range of positions and a second or “pawl non-release” range of positions. Power release gear 52 is driven by worm gear 50 in response to actuation of power release motor 46 and, in turn, drives power release cam 54 which controls the pivoting movement of pawl release lever 40 between its home and pawl release positions. The tooth mesh characteristics of power release gear 52 and worm gear 50 establish a reduction ratio torque multiplication between motor shaft 48 and power release cam 54.

The power release actuator may be used as part of a passive entry system to provide the power release feature. When a person approaches vehicle 14 with an electronic key fob and actuates outside door handle 24, an electronic latch release system associated with vehicle 14 senses both the presence of the key fob and that outside door handle 24 has been actuated (e.g. via communication between a switch 28 and an electronic control unit (ECU) shown at 60 that at least partially controls the operation of closure latch assembly 10). In turn, ECU 60 actuates the power release actuator to actuate the latch release mechanism for releasing the latch mechanism and unlatch closure latch assembly 10 so as to open the vehicle door.

The power lock actuator controls the operative connection between an inside release lever 62 associated with the inside door release mechanism and pawl release lever 40. The power lock actuator includes, among other things, a power lock electric motor 64 and a lock a 66.

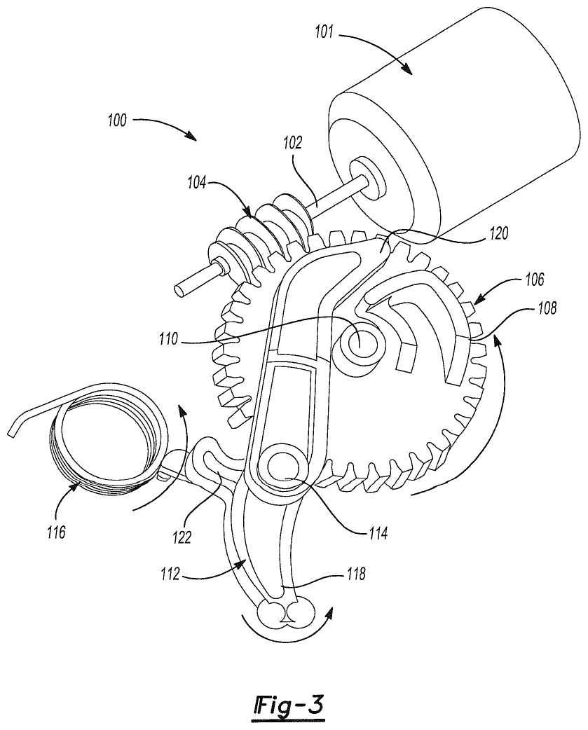

Referring now to FIG. 3, the components associated with a non-limiting embodiment of a power release actuator 100 adapted for use with closure latch assembly 10 are shown to include a power release electric motor 101 with a motor shaft 102 driving a worm gear 104, and a power release gear 106 having a release cam 108 formed thereon. Power release gear 106 is rotatable about a post 110 in a first or “releasing” (i.e. counterclockwise) direction and a second or “resetting” (i.e. clockwise) direction via actuation of power release motor 101. Power release gear 106 is rotatable about post 110 between a “home” position (shown) and a “released” position for causing pivotal movement of an actuator release lever 112 from a first or “non-actuated” position (shown) into a second or “actuated” position. Actuator release lever 112 is supported for pivotal movement relative to a pivot post 114 and is normally biased toward its non-actuated position by an actuator lever spring 116. Actuator lever 112 is operable in its non-actuated position to disengage its first leg segment 118 from pawl release lever 40, when located in its home position, so as to permit pawl 32 to remain in its ratchet holding position. In contrast, movement of actuator lever 112 from its non-actuated position to its actuated position causes its first leg segment 118 to engage and pivot pawl release lever 40 from its home position to its pawl release position, thereby causing pawl 32 to move from its ratchet holding position to its ratchet releasing position. A second leg segment 120 of actuator release lever 112 is engageable with release cam 108 due to the biasing of actuator lever spring 116. As such, rotation of power release gear 106 in its releasing direction from its home position to its released position causes corresponding pivotal movement of actuator release lever 112 from its non-actuated position into its actuated position. Likewise, rotation of power release gear 106 in its resetting direction from its released position to its home position results in corresponding pivotal movement of actuator release lever 112 from its actuated position to its non-actuated position.

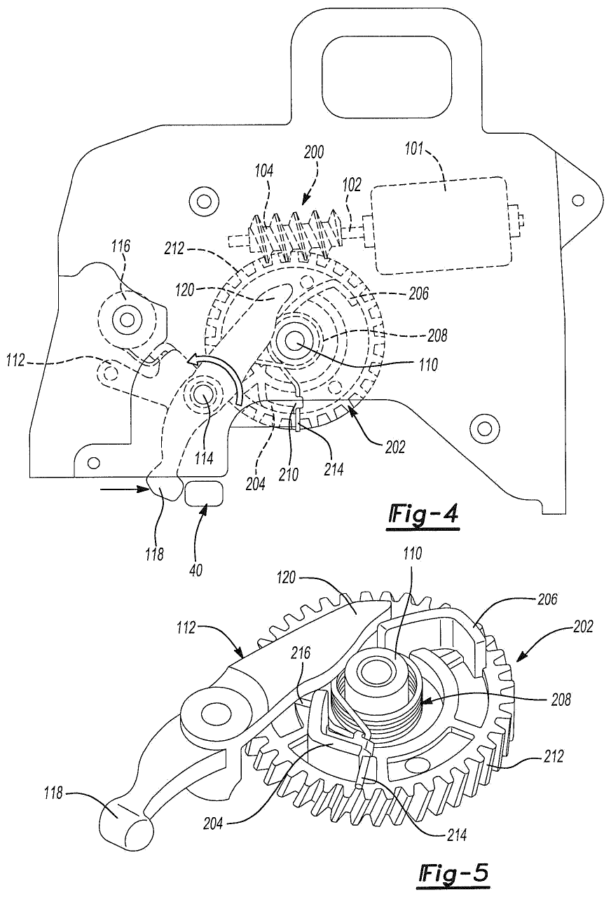

Referring now to FIG. 4, a power release actuator 200 is shown which is generally a modified version of power release actuator 100 (FIG. 3) and includes many similar components identified hereinafter and in the drawings using common reference numerals. Power release actuator 200 is configured to provide a bi-directional releasing function, with each directional releasing operation associated with a distinct operating mode for closure latch assembly 10. As seen, power release actuator 200 includes power release electric motor 101 with its motor shaft 102 driving worm gear 104, a power release gear 202 supported by rotation about an axis of a shaft for example, having a power release cam 204 and an emergency release cam 206, and a return spring 208 acting between power release gear 202 and a latch housing 210. Power release actuator 200 is illustratively shown as having a transmission chain formed from various components rotatable about an axis, such as a shaft of the component. Power release gear 202 has gear teeth 212 meshed with worm gear 104 such that rotation of motor output shaft 102 in a first direction causes corresponding rotation of power release gear 202 in a first (i.e. clockwise) direction and rotation of motor output shaft 102 in a second direction causes corresponding rotation of power release gear 202 in a second (i.e. counterclockwise) direction.

Power release gear 202 is shown in FIGS. 4, 5, 6A and 7A located in a neutral/home position with actuator release lever 112 located in its non-actuated position such that pawl release lever 40 is located in its home position with pawl 32 located in its ratchet holding position, thereby maintaining ratchet 30 in its striker capture position for establishing the Latched mode of closure latch assembly 10. In its neutral/home position, power release gear 202 is positioned such that neither of power release cam 204 and emergency release cam 206 are acting on actuation leg segment 120 of actuator release lever 112.

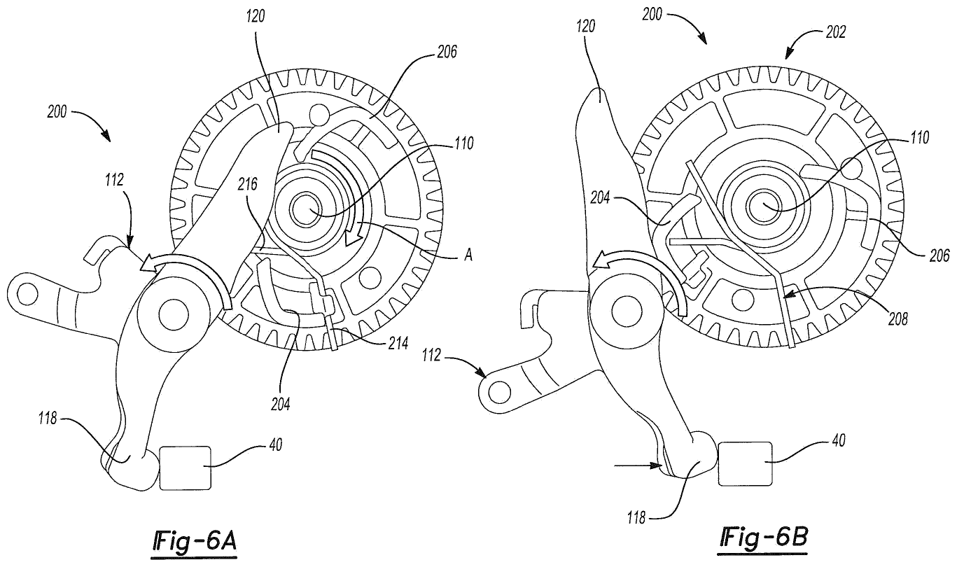

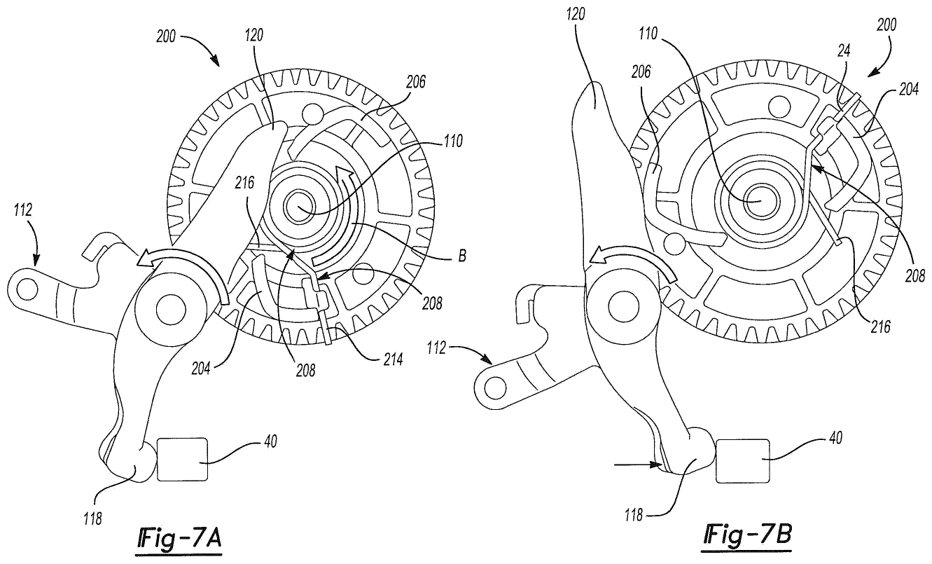

When control unit 60 indicates that closure latch assembly 10 is supplied with electrical power from the vehicle's primary power source (i.e. the battery), power release actuator 200 is considered to be operating in a “normal release” mode (for example, there is not a power failure). As such, when a power release signal is provided to closure latch assembly 10, power release electric motor 101 is energized to rotate power release gear 202 in a first releasing direction (i.e. clockwise), as indicated by arrow “A” illustrated in FIG. 6A, from its neutral/home position (shown in FIG. 6A) to a first released position (shown in FIG. 6B). As illustrated in the progression from FIG. 6A to FIG. 6B, the cam 204 has moved. Such rotation of power release gear 202 causes power release cam 204 to engage actuator leg segment 120 of actuator release lever 112 and forcibly pivot actuator release lever 112, in opposition to the biasing of spring 116, from its non-actuated position to its actuated position for causing pawl 32 to move to its ratchet releasing position, thereby releasing ratchet 30 for movement to its striker release position. As shown in FIG. 6B, pawl release lever 40 has been forced to the right by leg segment 118 of actuator lever 112. However, such rotation of power release gear 202 causes return spring 208 to be compressed (i.e. loaded) since its first end segment 214 is secured to power release gear 202 and its second end segment 216 engages a stationary portion of latch housing 210. Upon completion of the power release of the latch mechanism, a non-powered resetting function is completed. Specifically, power release motor 101 is turned off and return spring 208 backdrives power release gear 202 from its first released position (FIG. 6B) back to its neutral/home position (FIG. 6A) which, in turn, backdrives motor shaft 102 and electric motor 101. Since power release gear 202 is mechanically reset during operation of closure latch assembly 10 in its normal operating mode, no noise is generated as is typically associated with powered resetting of the power release actuator.

When control unit 60 indicates that closure latch assembly 10 is not supplied with electrical power from the vehicle's primary power source and may be relying on a backup power source (i.e. supercapacitors), power release mechanism 200 is considered to be operating in an “emergency release” mode. As such, when a signal is provided to release closure latch assembly 10, power release motor 101 is energized to rotate power release gear 202 in a second releasing direction (i.e. counterclockwise), as indicated by arrow “B” (shown in FIG. 7A), from its neutral/home position (FIG. 7A) to a second released position (FIG. 7B). Such rotation of power release gear 202 causes emergency release cam 206 to engage actuation leg segment 120 and forcibly pivot actuator release lever 112, in opposition to the biasing of spring 116, from its non-actuated position into its actuated position for causing pawl 32 to move to its ratchet releasing position, thereby releasing ratchet 30 for movement to its striker release position. However, such rotation of power release gear 202 in the second releasing direction does not act to cause return spring 208 to be loaded since its second end segment 216 is no longer engaged with a stationary component of latch housing 210. Thus, power release gear 202 is held in its second released position. Subsequent resetting of power release actuator 200, required for moving power release gear 202 from its second released position back to its neutral/home position, is completed either manually (if no power) or electrically (via backup power) by driving power release motor 101 in the opposite direction.

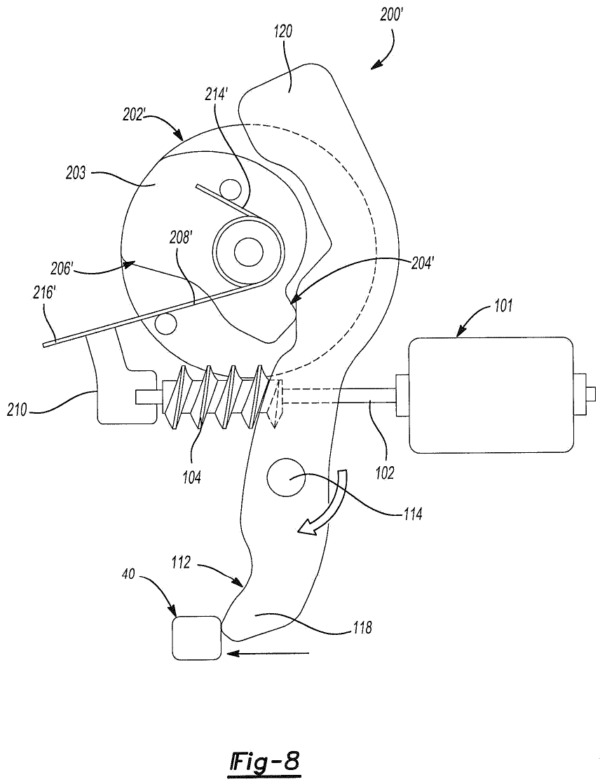

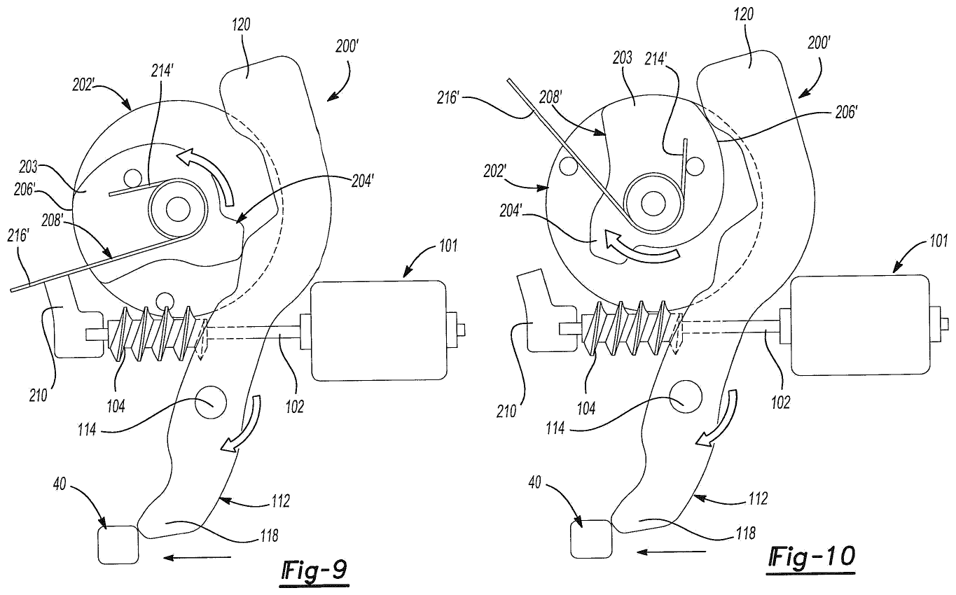

Referring now to FIGS. 8-10, a modified version of power release actuator 200 is shown as power release actuator 200′ and is generally identical thereto with the exception that power release gear 202′ has a common cam 203 defining both a power release cam segment 204′ and an emergency release cam segment 206′. In other words, a single integral common cam is provided that defines both the power release cam and the emergency release cam. Otherwise, the functionality and operation of power release actuator 200′ is substantially similar to that of power release actuator 200.

As noted above, a non-powered reset function is provided in association with power release actuator 200 of closure latch assembly 10 via use of return spring 208 acting on power release gear 202 for backdriving motor shaft 102 of power release motor 101. The use of return spring 208 downstream of the gear reduction unit (power release gear 202 and worm gear 104) provides a gear ratio between power release gear 202 and motor shaft 102 that assists in providing sufficient torque to effectively back drive electric motor 101 and provide the non-powered reset function of the latch release mechanism.

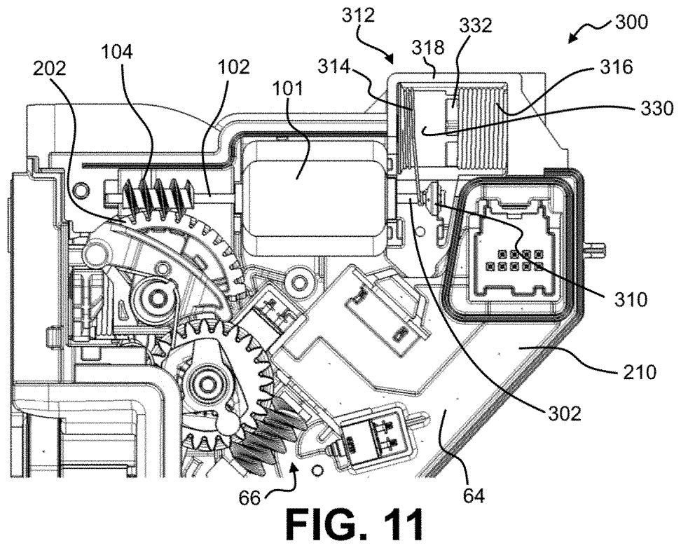

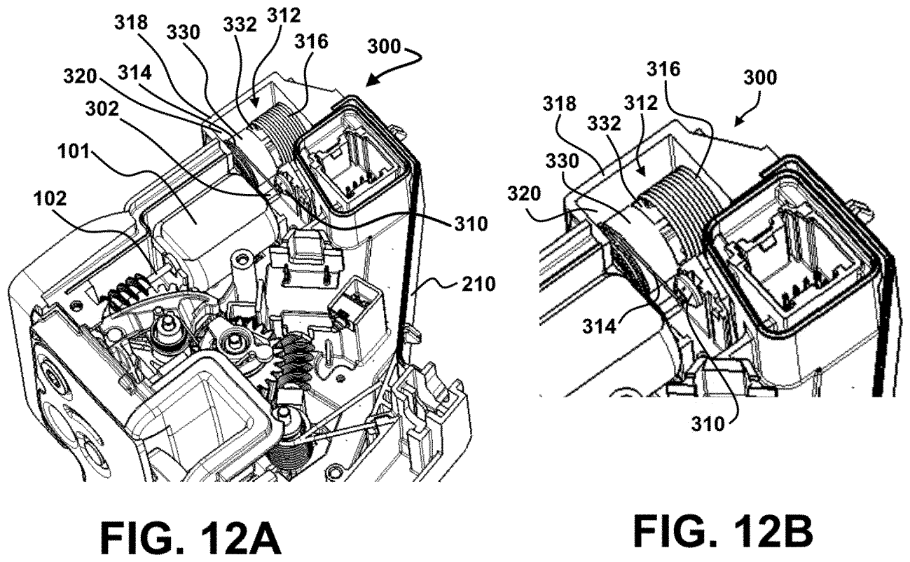

As an alternative to the above arrangement, FIGS. 11-13 illustrate a motor reset mechanism 300 acting directly on a shaft extension segment 302 of motor shaft 102 of power release motor 101 and which is adapted for installation within a slightly modified version of closure latch assembly 10. Reset mechanism 300 in other possible configurations may act directly or indirectly on a shaft of a component of a transmission chain. For example, reset mechanism 300 may act directly on the portion of the motor shaft 102 extending between the motor 101 and the worm gear 104. In another example configuration, reset mechanism 300 may act directly on another shaft of a component such as on a shaft of the power release gear 202. In other possible configurations, reset mechanism 300 may act on a pulley feature formed directly on the component of the transmission chain or on a feature, such as a drum or cam, affixed to the shaft of the component. Accordingly, the following detailed description of the components, configuration and functionality of motor reset mechanism 300, while shown in association with power release motor 101 of power release actuator 200, is non-limiting and considered applicable to any power-operated “actuatable” mechanism (i.e. power release, power cinch, power lock, door presenters, etc.) requiring a non-powered reset function. For example, the arrangement of FIGS. 11-13 may be applied to the motors 101 described previously, and may replace the springs 208.

Referring now to FIGS. 11-13, motor reset mechanism 300 is shown in this non-limiting configuration, to generally include an arbor 310 fixed for common rotation with shaft extension segment 302 of motor shaft 102, a pulley unit 312, a string or drive cable 314 interconnecting pulley unit 312 to arbor 310, and a reset spring 316. The string may be formed of a polymer material, a metal material, or a material consisting of threads of cotton, hemp, or other material twisted together, as non-limiting examples. In one aspect, the shaft extension segment 302 and the motor shaft 102 are fixed for common rotation. In one aspect, the shaft extensions segment 302 and the motor shaft 102 are integrally formed as a single piece.

Latch housing 210 is shown to include a reset mechanism housing section 318 defining a drive chamber 320 (shown in FIGS. 12A and 12B). Drive chamber 320 may have various sizes and shapes to accommodate the various components disposed therein. Shaft extension segment 302 of motor shaft 102 is shown rotatably supported by a boss segment 322 of housing section 318. The boss segment 322 may form a portion of wall section of the like that defines the drive chamber 320. Arbor 310 is shown fixed to shaft extension segment 302 in proximity to boss segment 322.

In one aspect, pulley unit 312 is disposed within chamber 320 and generally includes a pulley segment 330 and a pulley shaft segment 332. Pulley shaft segment 332 has its opposite ends supported in retention apertures formed in the sidewalls of housing section 318 within chamber 320 to rotatably mount pulley unit 312 therein. Pulley shaft segment 332 may include various bearing elements or structure to improve rotation relative to the housing section 318 in which it is mounted.

Reset spring 316 may be utilized to backdrive the motor 101, rather than through the use of a spring on the gear 202 described previously. Reset spring 316 is shown to be a coil spring arranged to surround pulley shaft segment 332 of pulley unit 312. Coil spring 316 acts between pulley shaft segment 332 and latch housing section 318 and, as will be detailed, is pre-loaded to provide a directional bias. Drive cable 314 is wound partially on pulley segment 330 and has a first cable end fixedly secured to arbor 310 and a second cable end fixedly secured to pulley segment 330. Drive cable 314 is configured to be wound around shaft extension segment 302 during actuation of the motor 101 while being unwound from the pulley segment 330. Thus, as winding increases on the shaft extension segment 302, winding decreases on the pulley segment 330, and vice versa.

FIGS. 12A and 12B illustrate motor reset mechanism 300 operating in a first or “rest” (spring-released) state that is established when power release motor 101 is operating in its non-powered state and the latch release mechanism is operating in its non-actuated state such that motor shaft 102 is located in a rest position. As noted, coil spring 316 is pre-loaded when motor shaft 102 located in its rest position such that it generates a pull force on drive cable 316 resulting in a reset torque being exerted on motor shaft 102. The reset torque functions to positively locate motor shaft 102 in its rest position and is greater than the torque required to rotate motor shaft 102 (and the gear reduction unit) under a no-load condition for electric motor 101. Thus, the latch release mechanism is reset in its non-actuated state in preparation for subsequent signaling by ECU 60 of the next power release requirement. Thus, when the motor 101 is actuated, it must overcome the bias of the coil spring 316 on the drive cable 314, due to the drive cable 314 being wound onto the shaft extension segment 302 when the motor 101 is actuated.

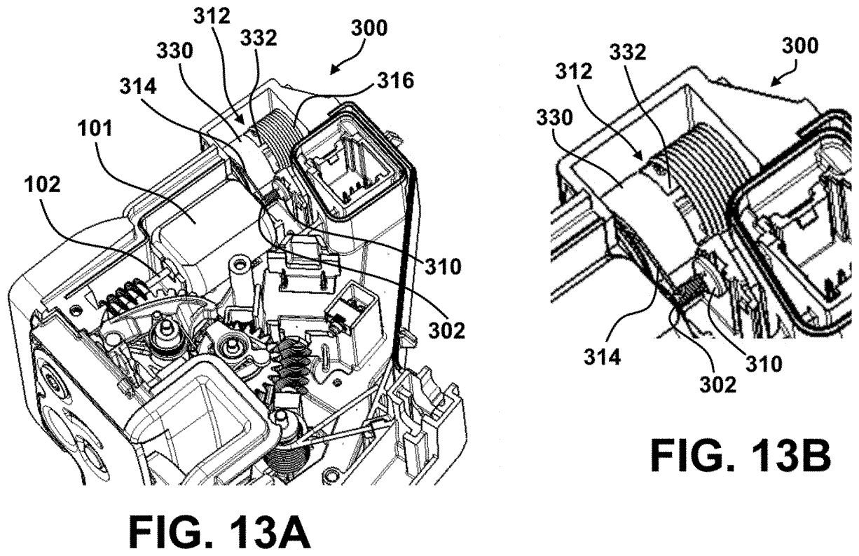

In contrast to FIGS. 12A and 12B, FIGS. 13A and 13B illustrates motor reset mechanism 300 operating in a second or “loaded” (spring-loaded) state established when electric motor 101 is powered and rotates motor shaft 102 in the actuation direction from its rest position to a power release position, whereby the latch release mechanism has been shifted into its actuated state (for example actuating the pawl to release the ratchet). As seen, this shifting of the latch release mechanism requires motor shaft 102 to be rotated through a plurality of complete rotations, as indicated by the number of winded loops of drive cable 314 on shaft extension 302. The increased winded loops of drive cable 314 on shaft extension 302 corresponds to a decrease of winded loops on the pulley segment 330. This cable “wrapping” action results in drive cable 314 rotating coil spring 316 as it unwinds from the pulley segment 330, in opposition to its normally biasing direction, and functions to store a spring load in pulley unit 312. The direction of the spring load on the drive cable 314 is the same direction as the pre-load described above.

As can be seen in FIGS. 13A and 13B, the cable 314 is wound around the shaft extension 302 a greater amount than shown in FIG. 12A, 12B, and the cable is wound around the pulley segment 330 a lesser amount relative to FIG. 12A, 12B. In FIG. 13A, 13B, the coil spring 316 is loaded to provide tension on the cable 314 that will rotate the motor 101 in the opposite direction of its actuation after power to the motor 101 is ceased.

Upon completion of the latch release mechanism being shifted into its actuated state, electric motor 101 is shifted into its power-off state. In the power-off state, the motor 101 may be allowed to rotate the opposite direction in response to a rotational load on the motor shaft 102 and/or shaft extension 302, because the load from the motor 101 is no longer overcoming the bias of the spring 316. As such, the stored spring load is released and reset mechanism 300 functions to generate a sufficient reset torque capable of driving motor shaft 102 back to its rest position, thereby providing the non-powered reset function. The spring load is sufficient to overcome any frictional forces on the gear mechanisms or rotational resistance of the motor 101, and/or inertial loads in the stackup of components.

The configuration of reset mechanism 300 as a spring-loaded belt-type (i.e. pulley) reduction mechanism provides a ratio reduction between coil spring 316 and motor shaft 102 that is selected to generate sufficient reset torque for completely rotating motor shaft 102 back to its rest position. This ratio reduction established because of the relative diameters of pulley segment 332 and motor shaft extension 302, reduces the rotary motion of coil spring 316 that is required to generate the reset torque. This solution provides a configuration for locating a spring-type reset mechanism upstream of electric motor 101 so as to overcome the issues and problems associated with conventional arrangements.

The mechanism 300 may be used as the sole reset mechanism associated with the motor 101, thereby replacing the reset mechanism associated with the gear train downstream of the motor 101 that interfaces with the motor shaft 102. Alternatively, the mechanism 300 may be used in addition to the mechanism associated with the downstream gear train, thereby allowing for a combination of the return forces provided by both the upstream and downstream mechanisms.

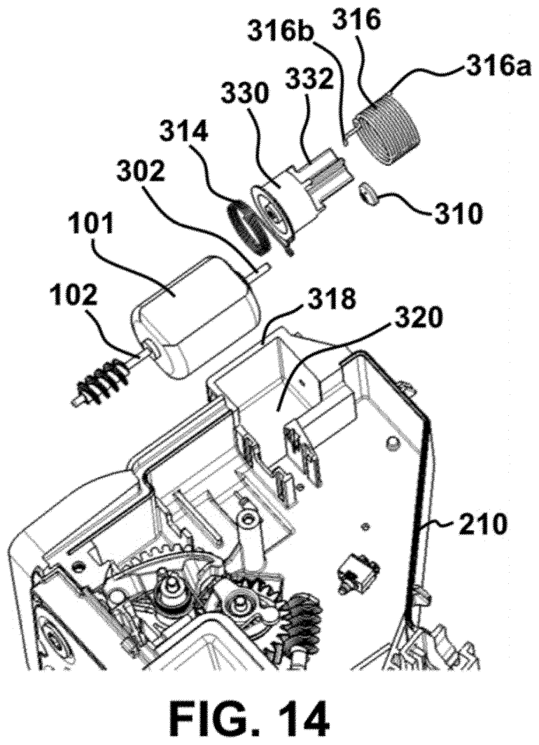

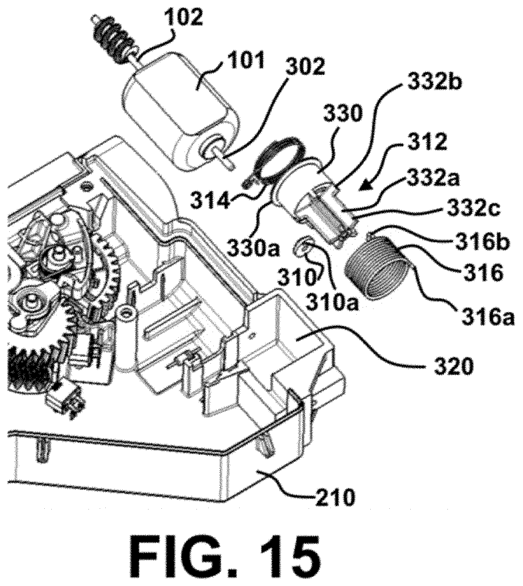

With reference to FIGS. 14 and 15, exploded views of the components of the mechanism 300 are shown, further illustrating the size and shape of said components.

For example, the spring 316 is illustrated showing a first end 316a and a second end 316b. The first end 316a of the spring is configured to be fixed to the housing section 318, and the second end 316b is configured to be fixed to the pulley unit 312.

The portions of the pulley unit 312 are shown in additional detail. The pulley unit 312 includes the pulley segment 330 and the pulley shaft segment 332. The pulley segment 330 has a generally cylindrical profile, configured for the drive cable 314 to be wrapped around the round cylindrical profile.

The pulley shaft segment 332 may have a spoke profile, including a plurality of spokes 332a radiating outward from the rotational axis of the pulley unit 312. The spokes 332a are arranged to support the coil spring 316 thereon. The spokes 332a may have a wide section 332b and a narrow section 332c. The narrow section 332c may be sized to accommodate the diameter of the coil spring 316, such that the coil spring 316 may be inserted over the narrow section 332c. The wide section may be sized to abut the end of the coil spring 316 and to axially retain the coil spring 316 against the housing 318.

The pulley segment 330, having the cylindrical profile around which the drive cable 314 winds, further includes a radially extending flange portion 330a at the end of the pulley segment 330. The flange portion 330a is operable to retain the drive cable 314 axially on the pulley segment 330 to prevent the drive cable from translating off the end of the pulley segment 330 as it is wound and unwound.

The arbor 310 is also shown clearly in the exploded view. The arbor 310 may include a cavity, recess, or hole 310a to which one end of the drive cable 314 is attached. The arbor 310 is rotationally fixed to the shaft extension 302, so rotation of the shaft extension will cause rotation of the arbor 310, and the hole 310a to which the drive cable 314 is attached, thereby causing the drive cable to wrap around the shaft extension 302. The arbor 310 is further operable to retain the drive cable 314 on the shaft extension 302 as it is wound around the shaft extension 302.

The belt ratio between the pulley unit 312 and the shaft extension 302 is also more clearly illustrated in the exploded views. As shown, the diameter of the pulley segment 330, around which the drive cable 314 is wound, is substantially larger than the diameter of the motor shaft extension 302, around which the drive cable 314 is wound when the motor 101 is actuated. Due to the difference in diameter, the shaft extension 302 may rotate multiple times for each rotation of the pulley segment 330. Accordingly, the pulley segment 330 need only rotate a limited number of rotations to reset the motor 101.

Other aspects of the mechanism 300 are apparent from the figures. For example, as shown in FIG. 11, the pulley 312 axially overlaps the shaft extension 302 of the motor 101, and the axes of rotation of the motor 101 and the pulley 312 are generally parallel. The axes of rotation of offset laterally relative to each other. The motor 101 and pulley 312 are axially offset from each other, such that the motor 101 and the pulley 312 may radially overlap.

The arbor 310 may have a generally tapered shape, with an inner end (closer to the motor 101) having a reduced diameter relative to an outer end (away from the motor 101). This tapered shape may operate to urge the drive cable 314 away from the end of the shaft extension 302 as the drive cable 314 is wound around the shaft extension 302.

However, in an alternative aspect, the pulley unit 312 may have a reduced diameter relative to the diameter described above. In this case, the pulley unit 312 may require additional rotation to reset the motor 101 and rotate the shaft extension 302 a sufficient amount. Similarly, the shaft extension may have a larger diameter than that shown and described, thereby requiring additional rotation of the pulley unit 312 to cause sufficient rotation to reset the motor 101.

As described and shown, the spring 316 is in the form of a coil spring. However, it will be appreciated that other non-power rotational biasing mechanisms may be used to bias the pulley unit 312 toward the non-actuated state and in the reset direction. For example, various other spring types may be used.

The reset mechanism 300 has been shown disposed on an opposite end of the motor 101 from the motor shaft 102 and operable to rotate the shaft extension to reset the motor 101. In an alternative aspect, the drive cable 314 may be attached to the motor shaft 102 on the same side of the motor 101 as the motor shaft 102. Similarly, the arbor 310 and pulley unit 312 may be disposed adjacent the motor shaft 102 rather than via the shaft extension 302. In this aspect, the shaft extension 302 may not be used. The operation of the reset mechanism 300 in such an arrangement may be the same as described above.

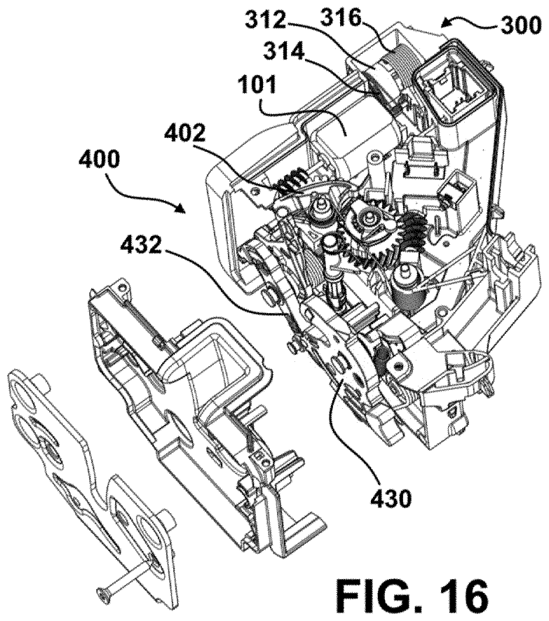

FIG. 16 illustrates an exploded view of a closure latch assembly 400 including a latch housing 410 having the motor reset mechanism 300 disposed therein along with a ratchet 430 and pawl 432 and additional latch components, and a gear 402 that is driven by the motor 101 and motor shaft 102. The gear 402 may be operable to actuate a latch release mechanism or a latch cinch mechanism, or any other closure latch assembly mechanism driven by the rotation of a gear in response to rotation of a motor shaft. For example, a latch cinch mechanism as shown US patent application No. US20160186468 (also referred to as the '468 application) entitled “Dual motor device with application to power cinch and latch mechanism”, the entire contents of which are incorporated herein by reference, may be adapted with the teachings described herein (for example, the shaft 74 or the shafts of motor(s) 70 of '468 application may be coupled with the motor reset mechanism 300).

Referring back to FIGS. 1 to 16, there is further provided a method of constructing a closure latch assembly including the steps of providing a closure latch assembly having a transmission chain actuated by an electric motor, coupling a reset mechanism to a rotatable component of the transmission chain, where the reset mechanism is shiftable to a spring-loaded state in response to rotation of the rotatable component in response to actuation of the electric motor and shiftable to a spring-released state in response to de-actuation of the electric motor. The reset mechanism is operable in its spring-released state to exert a reset torque to the rotatable component to rotate the component in a direction opposite the direction of rotation of the rotatable caused by actuation of the electric motor.

Referring back to FIGS. 1 to 16, there is further provided a method of resetting a rotatable component, the method including the steps of coupling a reset mechanism having a spring-loaded state and a spring-released state to the rotatable component of a transmission chain, shifting the reset mechanism to the spring-loaded state in response to a rotational torque exerted on the rotatable component in a first direction, and shifting the reset mechanism to a spring-released state in response the cessation of the rotational torque exerted on the rotatable component such that the reset mechanism is operable in its spring-released state to exert a reset torque to the rotatable component to rotate the component.

It will be appreciated that the motor reset mechanism 300 described herein may be applicable to a variety of other mechanisms and/or closure latch mechanisms, and may be operable to reset a variety of rotational components that are rotationally actuated and for which a rotation in the opposite direction at the conclusion of the actuation is desirable.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A closure latch assembly for a closure panel of a motor vehicle, comprising:
a latch mechanism operable in a first state to locate the closure panel in a first position and in a second state to locate the closure panel in a second position;
a power actuator including an actuatable mechanism, an electric motor having a rotary motor shaft, and a reset mechanism, the actuatable mechanism being operable in a non-actuated state to permit the latch mechanism to operate in its first state and in an actuated state to shift the latch mechanism from its first state into its second state, the electric motor being operable in a power-on state to drive the rotary motor shaft in an actuation direction for causing the actuatable mechanism to shift from its non-actuated state into its actuated state, the reset mechanism operatively connected to the motor shaft and being shifted into a spring-loaded state in response to rotation of the motor shaft in the actuation direction from a first position to a second position, the reset mechanism being shifted from its spring-loaded state into a spring-released state when the actuatable mechanism is in its actuated state and the electric motor is shifted into a power-off state,
wherein the reset mechanism is operable in its spring-released state to exert a reset torque to the motor shaft for causing the motor shaft to rotate in a reset direction from its second position back to its first position so as to reset the actuatable mechanism in its non-actuated state for providing a spring-assisted non-powered reset function.

2. The closure latch assembly of claim 1, wherein the actuatable mechanism is a latch release mechanism that is operable in its non-actuated state to maintain the latch mechanism in either of its first state, wherein the first state is a latched state, and its second state, wherein the second state is an unlatched state, wherein the latch release mechanism is further operable in its actuated state to mechanically shift the latch mechanism from its latched state into its unlatched state, wherein the latch mechanism is operable in its latched state to hold the closure panel in its first position, wherein the first position is a closed position, and is further operable in its unlatched state to permit movement of the closure panel to its second position, wherein the second position is an open position, wherein shifting of the reset mechanism from its spring-released state to its spring-loaded state occurs in response to the electric motor operating in its power-on state to drive the motor shaft from its first position into its second position, and wherein shifting of the reset mechanism from its spring-loaded state to its spring-released state permits the reset torque to be exerted on the motor shaft and cause the motor shaft to rotate from its second position to its first position while the electric motor is maintained in its power-off state.

3. The closure latch assembly of claim 2, wherein the latch mechanism includes a ratchet and a pawl, the ratchet being moveable between a striker release position whereat a striker fixed to a vehicle body is displaced from engagement with the ratchet and a striker capture position whereat the ratchet retains and holds the striker, the ratchet being biased toward its striker release position, the pawl being moveable between a ratchet releasing position whereat the ratchet is permitted to move toward its striker release position and a ratchet holding position whereat the pawl holds the ratchet in its striker capture position, the pawl being biased toward its ratchet holding position, the latch mechanism is operating in its unlatched state when the ratchet is located in its striker release position and is operating in its latched state when the ratchet is held in its striker capture position,
wherein the latch release mechanism includes a release cam rotatably driven by the electric motor between a home position whereat the pawl is maintained in its ratchet holding position and a pawl release position whereat the pawl moves to its ratchet releasing position, the latch release mechanism is operating in its non-actuated state when the release cam is located in its home position and is operating in its actuated state when the release cam is located in its pawl release position,
wherein movement of the release cam from its home position to its pawl release position is caused by rotation of the motor shaft in the actuation direction for providing a power release function, and movement of the release cam from its pawl release position to its home position is caused by rotation of the motor shaft in the reset direction for providing a non-powered reset function.

4. The closure latch assembly of claim 1, wherein the actuatable mechanism is a latch cinch mechanism operable in its non-actuated state when the latch mechanism is operating in its first state, wherein the first state is a secondary latched state, for holding the closure panel in its first position, wherein the first position is a partially-closed position, wherein the latch cinch mechanism is also operable in its actuated state to shift the latch mechanism from its secondary latched state into its second state, wherein the second state is a primary latched state, for moving the closure panel from its partially-closed position to its second position, wherein the second position is a fully-closed position, and wherein the shifting of the reset mechanism into its spring-released state results in a spring-assist force being applied to the motor shaft for shifting the latch cinch mechanism into its non-actuated state while the latch mechanism is held in its primary latched state.

5. The closure latch assembly of claim 1, wherein the reset mechanism is a spring-loaded pulley system coupled to the motor shaft of the electric motor.

6. The closure latch assembly of claim 5, wherein the spring-loaded pulley system is connected to a shaft extension segment of the motor shaft.

7. The closure latch assembly of claim 5, wherein the spring-loaded pulley system includes a pulley, a drive cable connecting the pulley to the motor shaft, and a reset spring acting on the pulley and configured to exert a reset torque causing the motor shaft to be biased for rotation in the reset direction.

8. The closure latch assembly of claim 7, wherein the reset spring is a coil spring acting between the pulley and a stationary member.

9. The closure latch assembly of claim 1, wherein the reset mechanism is operatively connected to the motor shaft by a drive cable.

10. A power actuator for a closure latch assembly having a latch mechanism operable in a first state to locate a closure panel in a first position and in a second state to locate the closure panel in a second position, the power actuator including an actuatable mechanism, an electric motor having a rotary motor shaft, and a reset mechanism, the actuatable mechanism being operable in a non-actuated state to permit the latch mechanism to operate in its first state and in an actuated state to shift the latch mechanism from its first state into its second state, the electric motor being operable in a power-on state to drive the motor shaft in an actuation direction for causing the actuatable mechanism to shift from its non-actuated state into its actuated state, the reset mechanism operatively connected to the motor shaft and being shifted into a spring-loaded state in response to rotation of the motor shaft in the actuation direction from a first position to a second position, the reset mechanism being shifted from its spring-loaded state into a spring-released state when the actuatable mechanism is in its actuated state and the electric motor is shifted into a power-off state,
wherein the reset mechanism is operable in its spring-released state to exert a reset torque on the motor shaft for causing the motor shaft to rotate in a reset direction from its second position back to its first position so as to reset the actuatable mechanism in its non-actuated state for providing a spring-assisted non-powered reset function.

11. The power actuator of claim 10, wherein the actuatable mechanism is a latch release mechanism that is operable in its non-actuated state to maintain the latch mechanism in either of its first state, wherein the first state is a latched state, and its second state, wherein the second state is an unlatched state, wherein the latch release mechanism is further operable in its actuated state to mechanically shift the latch mechanism from its latched state into its unlatched state, wherein the latch mechanism is operable in its latched state to hold the closure panel in its first position, wherein the first position is a closed position, and is further operable in its unlatched state to permit movement of the closure panel to its second position, wherein the second position is an open position, wherein shifting of the reset mechanism from its spring-released state to its spring-loaded state occurs in response to the electric motor operating in its power-on state to drive the motor shaft from its first position into its second position, and wherein shifting of the reset mechanism from its spring-loaded state to its spring-released state permits the reset torque to be exerted on the motor shaft and cause the motor shaft to rotate from its second position to its first position while the electric motor is maintained in its power-off state.

12. The power actuator of claim 11, wherein the latch mechanism includes a ratchet and a pawl, the ratchet being moveable between a striker release position whereat a striker fixed to a vehicle body is displaced from engagement with the ratchet and a striker capture position whereat the ratchet retains and holds the striker, the ratchet being biased toward its striker release position, the pawl being moveable between a ratchet releasing position whereat the ratchet is permitted to move toward its striker release position and a ratchet holding position whereat the pawl holds the ratchet in its striker capture position, the pawl being biased toward its ratchet holding position, the latch mechanism is operating in its unlatched state when the ratchet is located in its striker release position and is operating in its latched state when the ratchet is held in its striker capture position,
wherein the latch release mechanism includes a release cam rotatably driven by the electric motor between a home position whereat the pawl is maintained in its ratchet holding position and a pawl release position whereat the pawl moves to its ratchet releasing position, the latch release mechanism is operating in its non-actuated state when the release cam is located in its home position and is operating in its actuated state when the release cam is located in its pawl release position,
wherein movement of the release cam from its home position to its pawl release position is caused by rotation of the motor shaft in the actuation direction for providing the power release function, and movement of the release cam from its pawl release position to its home position is caused by rotation of the motor shaft in the reset direction for providing a non-powered reset function.

13. The power actuator of claim 10, wherein the actuatable mechanism is a latch cinch mechanism operable in its non-actuated state when the latch mechanism is operating in its first state, wherein the first state is a secondary latched state, for holding the closure panel in its first position, wherein the first position is a partially-closed position, wherein the latch cinch mechanism is also operable in its actuated state to shift the latch mechanism from its secondary latched state into its second state, wherein the second state is a primary latched state, for moving the closure panel from its partially-closed position to its second position, wherein the second position is a fully-closed position, and wherein the shifting of the reset mechanism into its spring-released state results in the reset torque being applied to the motor shaft for shifting the latch cinch mechanism into its non-actuated state while the latch mechanism is held in its primary latched state.

14. The power actuator of claim 10, wherein the reset mechanism is a spring-loaded pulley system coupled to the motor shaft of the electric motor.

15. The power actuator of claim 14, wherein the spring-loaded pulley system is connected to a shaft extension segment of the motor shaft.

16. The power actuator of claim 14, wherein the spring-loaded pulley system includes a pulley, a drive cable connecting the pulley to the motor shaft, and a reset spring acting on the pulley and configured to exert a spring biasing load causing the motor shaft to be biased for rotation in the reset direction.

17. The power actuator of claim 10, wherein the reset mechanism is operatively connected to the motor shaft by a drive cable.

18. A non-powered motor reset mechanism for use in a closure latch assembly for a closure panel of a motor vehicle, the non-powered motor reset mechanism comprising:
a power actuator including an actuatable mechanism;
an electric motor operable in a first rotational direction from a non-actuation position to an actuated position to actuate the actuatable mechanism and operable in a second rotational direction from the actuated position to the non-actuated position to reset the actuatable mechanism;
a rotatable pulley unit operatively coupled to the electric motor, wherein the rotatable pulley unit has a rest position and a loaded position, wherein the rotatable pulley has a bias toward the rest position;
a drive cable coupled to the pulley unit and configured to be wound and unwound from the pulley unit in response to rotation of the pulley unit, wherein the drive cable is further attached to the electric motor;
wherein, in response to actuation of the motor, rotation of the motor in the first rotational direction causes rotation of the pulley unit toward the loaded position and unwinds the drive cable from the pulley unit and increases a tension on the drive cable and the bias of the pulley unit;
wherein, in response to ceasing actuation of the motor, the bias of the pulley unit causes rotation of the motor in second rotational direction and winds the drive cable on the pulley unit.

19. The non-powered reset mechanism of claim 18, wherein the pulley unit includes a spring attached thereto, wherein the spring biases the pulley unit toward the rest position, wherein the spring provides a biasing force when the pulley unit is in the rest position.

20. The non-powered reset mechanism of claim 18, wherein the drive cable is coupled to a shaft extension of the motor, wherein rotation of the motor winds the drive cable around the shaft extension and unwinds the drive cable from the pulley unit.

21. The non-powered reset mechanism of claim 20, wherein a diameter of the pulley unit is greater than a diameter of the shaft extension, wherein the pulley unit rotates less than the shaft extension to reset the motor.

22. The non-powered reset mechanism of claim 18, wherein when the motor is rotated to the actuation position, torque provided on the drive cable by the pulley unit is greater than a torque required to rotate the motor and a gear train driven by the motor under no load condition, wherein ceasing actuation of the motor provides a no load condition, and wherein the torque provided on the drive cable causes the motor to reset under the no load condition.
